(19) United States
(12) Patent Application Publication
(10) Pub. No.: US 2014/0002661 A1
(43) Pub. Date: Jan. 2, 2014

(54) TRAFFIC CAMERA DIAGNOSTICS VIA SMART NETWORK

(71) Applicants: Wencheng Wu, Webster, NY (US); Edul N. Dalal, Webster, NY (US)

(72) Inventors: Wencheng Wu, Webster, NY (US); Edul N. Dalal, Webster, NY (US)

(73) Assignee: XEROX CORPORATION, Norwalk, CT (US)

(21) Appl. No.: 13/538,447

(22) Filed: Jun. 29, 2012

(51) Int. Cl. H04N 17/06; H04N 7/18

(52) U.S. Cl. 348/149; 348/187; 348/159; 348/E17.002; 348/E07.085

(57) ABSTRACT

A method for detecting camera degradation and faults comprises identifying a plurality of cameras comprising a camera network, collecting at least one system metric indicative of the camera's performance, analyzing the system metrics according to at least one of a plurality diagnostics layers comprising an individual diagnostic layer, a network diagnostic layer, and a pair diagnostic layer, and identifying a fault condition indicative of a faulty camera in the camera network according to the diagnostic layers.

### TECHNICAL FIELD

Embodiments are generally related to the field of traffic cameras. Embodiments are also related to methods and systems for camera diagnostics applications. Embodiments are additionally related to methods and systems for detecting traffic camera degradation and faults.

### BACKGROUND OF THE INVENTION

Object tracking has become increasingly prevalent in modern applications. This is particularly true in the field of video surveillance and security applications, which are commonly used in transportation monitoring. As the number of surveillance and security cameras increase, maintenance of the cameras has become a significant challenge.

For example, in the cases of vehicle surveillance and traffic enforcement, the performance of a given camera will deteriorate over time until it eventually becomes inadequate for its traffic monitoring or enforcement tasks. Such deterioration may be gradual or sudden. Some examples of camera performance deterioration include image blurring (such as dirt on the camera lens), mis-orientation (accidental impact on the camera housing), and low image contrast (such as a flash defect or failure).

Several methods are known in the art for detecting such deterioration but known methods are complicated by the fact that there are multiple sources of noise that can reduce performance of a camera even when it is still working within its design parameters. As a result, known methods may mistakenly determine a working camera as faulty even if a tight tolerance threshold is used, or may be unable to promptly detect a faulty camera if a loose tolerance threshold is used.

One solution is to order maintenance anytime the possibility of a fault is detected, e.g., by using a tight tolerance threshold for diagnostics. However, this method is very expensive because it results in a high frequency of maintenance calls that turn out to be unnecessary, and therefore wastes valuable resources. A need exists for an improved method and system for identifying camera degradation and faults.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method and system for detecting camera degradation and faults.

It is another aspect of the disclosed embodiments to provide for an enhanced method and system for identifying cameras with a fault condition.

It is yet another aspect of the disclosed embodiments to provide an enhanced method and system for detecting camera degradation and faults using a smart network to identify a fault condition of the camera.

The aforementioned aspects and other objectives and advantages can now be achieved as described herein. A method for detecting camera error comprises identifying a plurality of cameras comprising a camera network, collecting at least one system metric indicative of the camera's performance, analyzing the system metrics according to at least one of a plurality of diagnostics layers comprising an individual diagnostic layer, a network diagnostic layer, and a pair diagnostic layer, and identifying a fault condition indicative of a faulty camera in the camera network according to the diagnostic layers. The individual diagnostic layer is also configured for tracking the system metrics for each of the cameras in the camera network and indicating a fault condition when the system metrics are degraded by more than a predetermined amount.

The network diagnostic layer is configured for tracking at least one individual system metric for each of the cameras in the camera network, tracking at least one collective system metric for all the cameras in the camera network, comparing the collective system metrics to the individual system metrics, and indicating a fault condition when the individual system metrics are worse than the collective system metrics by more than a predetermined amount.

In another embodiment the pair diagnostic layer is further configured for identifying at least one target object passing at least two of the cameras in the camera network, tracking the individual system metrics for each of the at least two cameras in the camera network, comparing the system metrics of the at least two cameras in the camera network, and indicating a fault condition when the system metrics of one of the at least two cameras in the camera network are worse than the system metrics of the remaining of the at least two cameras in the camera network by more than a predetermined amount.

Identifying a fault condition indicative of a faulty camera can further comprise applying at least two of the plurality of diagnostic layers comprising the individual diagnostic layer, the network diagnostic layer, and the pair diagnostic layer, and identifying a fault condition indicative of a faulty camera in the camera network when all of the at least two of the plurality of diagnostic layers applied indicates a fault condition.

The system metrics indicative of the camera's performance can comprise at least one of an automated license plate recognition yield, a negative of measured geometric distortion parameters of captured license plates, measured sharpness parameters of captured license plates, and Optical Character Recognition confidence levels. The plurality of cameras can comprise traffic surveillance video cameras.

In yet another embodiment a method for detecting camera error comprises identifying a plurality of cameras comprising a camera network, collecting at least one system metric indicative of the camera's performance, analyzing the system metrics according to at least one of a plurality of diagnostics layers comprising an individual diagnostic layer, a network diagnostic layer, and a pair diagnostic layer, applying at least two of the plurality of diagnostic layers comprising the individual diagnostic layer, the network diagnostic layer, and the pair diagnostic layer, and identifying a fault condition indicative of a faulty camera in the camera network when all of the at least two of the plurality of diagnostic layers applied indicates a fault condition.

The individual diagnostic layer is also configured for tracking the system metrics for each of the cameras in the camera network and indicating a fault condition when the system metrics are degraded by more than a predetermined amount.

The network diagnostic layer is further configured for tracking at least one individual system metric for each of the cameras in the camera network, tracking at least one collective system metric for all the cameras in the camera network, comparing the collective system metrics to the individual system metrics, and indicating a fault condition when the individual system metrics are worse than the collective system metrics by more than a predetermined amount.

The pair diagnostic layer is further configured for identifying at least one target object passing at least two of the cameras in the camera network, tracking at least one individual system metric for each of the at least two cameras in the camera network, comparing the individual system metrics of the at least two cameras in the camera network, and indicating a fault condition when the individual system metrics of one of the at least two cameras in the camera network are worse than the system metrics of the remaining of the at least two cameras in the camera network by more than a predetermined amount.

In another embodiment the at least one system metric indicative of the camera's performance can comprise at least one of an automated license plate recognition yield, a negative of measured geometric distortion parameters of captured license plates, measured sharpness parameters of captured license plates, and Optical Character Recognition confidence. The plurality of cameras can comprise traffic surveillance video cameras.

A system for detecting camera degradation and faults comprises a processor, a data bus coupled to the processor, and a computer-usable medium embodying computer code, the computer-usable medium being coupled to the data bus, the computer code comprising instructions executable by the processor configured for: identifying a plurality of cameras comprising a camera network, collecting at least one system metric indicative of the camera's performance, analyzing the system metrics according to at least one of a plurality of diagnostics layers comprising an individual diagnostic layer, a network diagnostic layer, and a pair diagnostic layer, and identifying a fault condition indicative of a faulty camera in the camera network according to the plurality of diagnostic layers.

The individual diagnostic layer is further configured for tracking the system metrics for each of the cameras in the camera network and indicating a fault condition when the system metrics are degraded by more than a predetermined amount.

The network diagnostic layer is further configured for tracking at least one individual system metric for each of the cameras in the camera network, tracking at least one collective system metric for all the cameras in the camera network, comparing the collective system metrics to the individual system metrics, and indicating a fault condition when the individual system metrics are worse than the collective system metrics by more than a predetermined amount.

The pair diagnostic layer is further configured for identifying at least one target object passing at least two of the cameras in the camera network; tracking the individual system metrics for each of the at least two cameras in the camera network; comparing the system metrics of the at least two cameras in the camera network; and indicating a fault condition when the system metrics of one of the at least two cameras in the camera network are worse than the system metrics of the remaining of the at least two cameras in the camera network by more than a predetermined amount.

In another embodiment, the instructions are further configured for applying at least two of the plurality of diagnostic layers comprising the individual diagnostic layer, the network diagnostic layer, and the pair diagnostic layer, and identifying a faulty camera when all of the at least two of the plurality of diagnostic layers applied indicates a fault condition.

In yet another embodiment the system metrics indicative of the camera's performance comprise at least one of an automated license plate recognition yield, a negative of measured geometric distortion parameters of captured license plates, measured sharpness parameters of captured license plates, and Optical Character Recognition confidence. The plurality of cameras can comprise traffic surveillance video cameras.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present invention may be implemented;

FIG. 3 depicts a high level flow chart illustrating logical operational steps in a method for detecting camera degradation and faults in accordance with the disclosed embodiments;

FIG. 4 depicts a high level flow chart illustrating logical operational steps in a method for detecting camera degradation and faults in accordance with another disclosed embodiment; and

FIG. 5 depicts a system for detecting camera degradation and faults in accordance with the disclosed embodiments.

### DETAILED DESCRIPTION

The particular values and configurations discussed in these non-limiting examples can be varied and are cited merely to illustrate at least one embodiment and are not intended to limit the scope thereof.

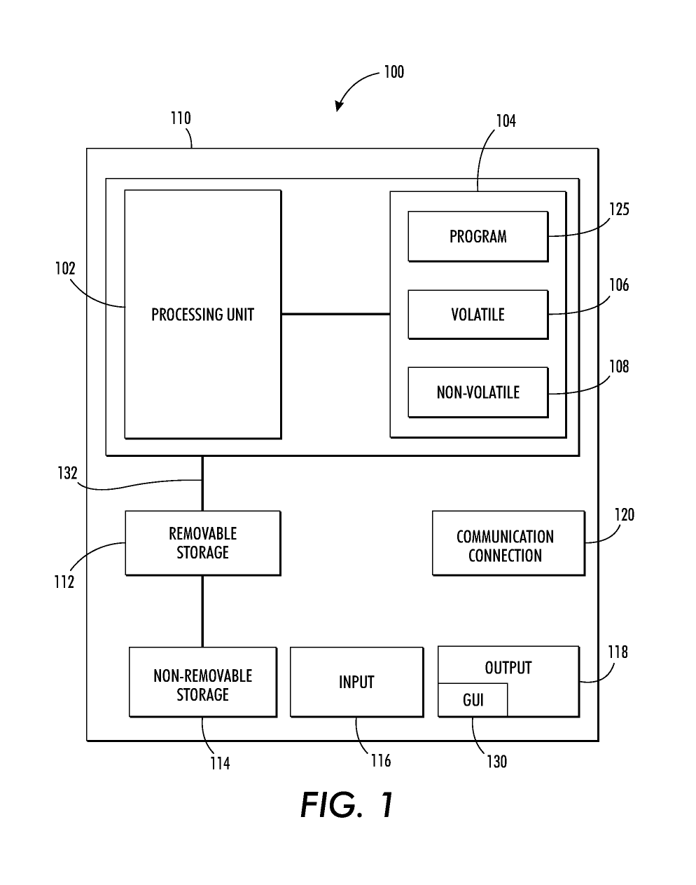

A block diagram of a computer system 100 that executes programming for executing the methods and systems disclosed herein is shown in FIG. 1. A general computing device in the form of a computer 110 may include a processing unit 102, memory 104, removable storage 112, non-removable storage 114, and a data bus 132. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions, as well as data, including video frames.

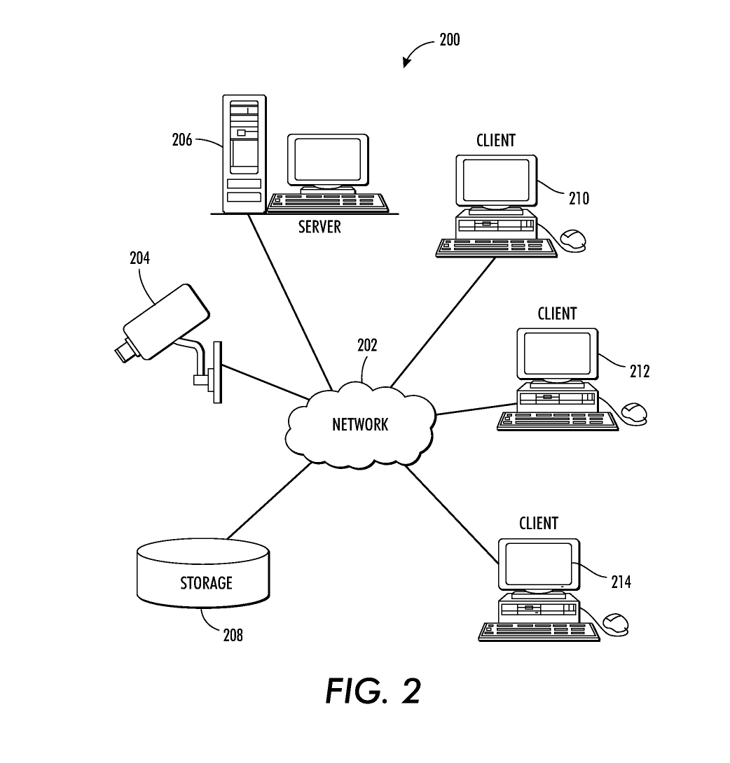

Computer 110 may include or have access to a computing environment that includes input 116, output 118, and a communication connection 120. The computer may operate in a networked environment using a communication connection to connect to one or more remote computers or devices. The remote computer may include a personal computer (PC), server, router, network PC, a peer device or other common network node, or the like. The remote device may include a still camera, video camera, tracking device, or the like. The communication connection may include a Local Area Network (LAN), a Wide Area Network (WAN) or other networks. This functionality is described in more detail in FIG. 2.

Output 118 is most commonly provided as a computer monitor but may include any computer output device. Output 118 may also include a data collection apparatus associated with computer system 100. In addition, input 116, which commonly includes a computer keyboard and/or pointing device such as a computer mouse, allows a user to select and instruct computer system 100. A user interface can be provided using output 118 and input 116.

Output 118 may function as a display for displaying data and information for a user and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module 125 which can be representative of other modules described herein, are stored on a computer-readable medium and are executable by the processing unit 102 of computer 110. Program module 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers in which embodiments of the present invention may be implemented. Note that the system 200 can be implemented in the context of a software module such as program module 125. The system 200 includes a network 202 in communication with one or more clients 210, 212, and 214. Network 202 is a medium that can be used to provide communications links between various devices and computers connected together within a networked data processing system such as computer system 100. Network 202 may include connections such as wired communication links, wireless communication links, or fiber optic cables. Network 202 can further communicate with one or more servers 206, one or more external devices such as video camera 204, and a memory storage unit such as, for example, memory or database 208.

In the depicted example, video camera 204 and server 206 connect to network 202 along with storage unit 208. Video camera 204 may alternatively be a still camera, surveillance camera, or traffic camera. In addition, clients 210, 212, and 214 connect to network 202. These clients 210, 212, and 214 may be, for example, personal computers or network computers. Computer system 100 depicted in FIG. 1 can be, for example, a client such as client 210, 212, and/or 214. In an alternative embodiment (not shown), clients 210, 212, and 214 may be, for example, a still camera, video camera, tracking device, etc.

Computer system 100 can also be implemented as a server such as server 206, depending upon design considerations. In the depicted example, server 206 provides data such as boot files, operating system images, applications, and application updates to clients 210, 212, and 214. Clients 210, 212, and 214 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 also may be implemented as a number of different types of networks such as, for example, an intranet, a local area network (LAN), or a wide area network (WAN). FIGS. 1 and 2 are intended as examples and not as architectural limitations for different embodiments of the present invention.

The following description is presented with respect to embodiments of the present invention, which can be embodied in the context of a data-processing system such as computer system 100, in conjunction with program module 125, and data-processing system 200 and network 202 depicted in FIGS. 1 and 2. The present invention, however, is not limited to any particular application or any particular environment. Instead, those skilled in the art will find that the system and methods of the present invention may be advantageously applied to a variety of system and application software including database management systems, word processors, and the like. Moreover, the present invention may be embodied on a variety of different platforms including Macintosh, UNIX, LINUX, and the like. Therefore, the descriptions of the exemplary embodiments, which follow, are for purposes of illustration and not considered a limitation.

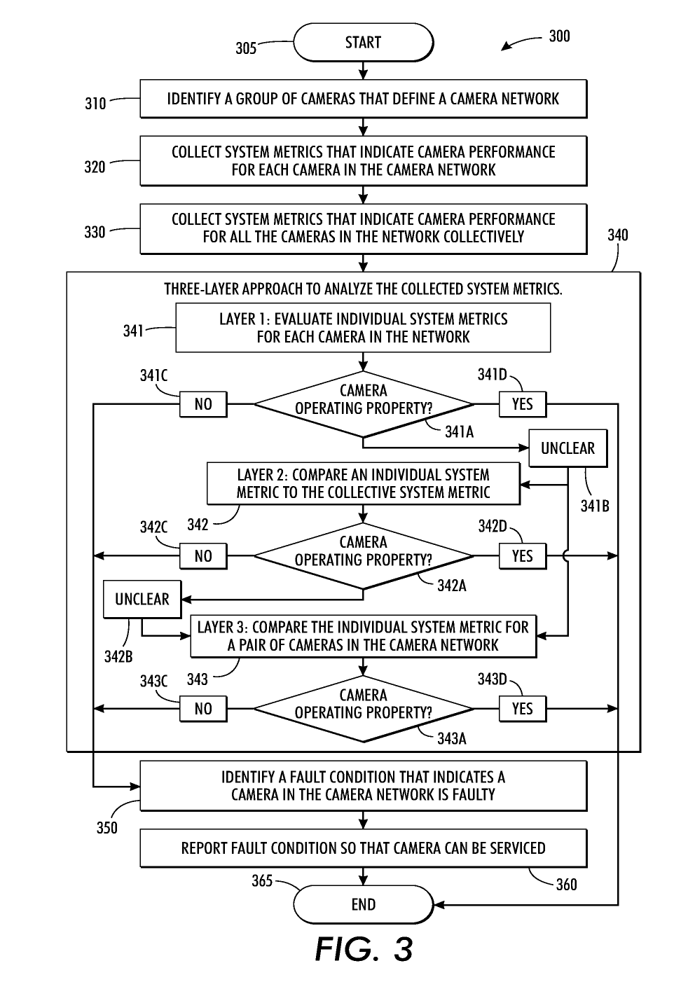

FIG. 3 illustrates a high level flow chart 300 of logical operational steps associated with a method for detecting camera degradation and faults in accordance with the disclosed embodiments. This method allows for the detection of a fault condition of a camera using a variety of diagnostic layers implemented with a smart network such as network 200. Most commonly, this method can be used in identifying faulty cameras used in monitoring, fee collection, and photo enforcement applications. The method begins at block 305.

Block 310 illustrates that a group of cameras that define a smart camera network can be identified. For purposes of implementing a three layered approach to identifying camera degradation and faults, the smart camera network is only necessary for layers two (network diagnostic layer) and three (pair diagnostic layer) because layer one (individual diagnostic layer) simply requires evaluating system metrics associated with an individual camera. The network of layer two can, and generally will, be different from the network of layer three. That is, the diagnostics of a camera could come from its individual performance track records, its relative performance to a smart network in layer two, and its relative performance to another smart network in layer three.

Next at block 320, system metrics indicative of camera performance can be collected for each camera in the smart camera network. In a preferred embodiment, the system metrics collected can be an Automated License Plate Recognition (ALPR) yield, a negative of measured geometric distortion parameters of captured license plates, measured sharpness parameters of captured license plates, and Optical Character Recognition (OCR) confidence levels.

For example, an ALPR recognition confidence level is a metric that indicates a statistical likelihood that the license plate associated with a vehicle captured by a camera was correctly identified. The ALPR yield can then be defined as the fraction of plates whose recognition confidence exceeds a predetermined threshold. For example, if the ALPR yield exceeds a threshold of 90%, the camera may be determined to be operating correctly. It should be appreciated that other metrics indicative of the performance of a camera can be additionally, or alternatively, used as a system metric in the present invention.

In addition, block 330 illustrates that system metrics can also be collected for all the cameras in the smart camera network and reduced to a single system metric for all the cameras in the network.

At block 340, a three-layered approach is employed to identify cameras with a fault condition. Block 341 shows layer one, also known as the individual diagnostic layer. In this layer, the individual system metrics for each camera are analyzed. If the camera is operating above a predetermined threshold, as shown at block 341a and decision block 341d, the camera is determined to be operating correctly and the method ends at block 365.

If a given camera is operating below a predetermined threshold at block 341, the camera can be determined to have a fault condition as indicated by block 341a and decision block 341c. In this case, the method moves to block 350. For example, for each camera a record of its ALPR yield over time (e.g., moving window average) can be monitored. If the ALPR yield drops by more than a pre-defined amount, a fault condition can be identified.

However, if a fault condition is detected by the individual diagnostic layer but it is unclear if the camera is operating properly as shown by block 341a and decision block 341b, further analysis is required to determine if a fault condition exists. For example, the ALPR yield can depend on a number of external factors, or noises, such as vehicle speed, environmental conditions such as rain, snow, fog, clouds, or sunlight, and quality of the identified plate. Therefore, a number of these noises may indicate the camera has a fault condition when the camera is actually operating correctly.

In another example of the individual diagnostic layer analysis, the distribution of geometric distortion parameters of captured license plates can be tracked over time for each camera to detect a change in the camera's filed of view. If the camera's field of view is reduced beyond a predefined threshold, the camera can be determined to have a fault condition. In this example, location of the plate on each vehicle and travel trajectory of each vehicle is noise factors that may indicate a fault condition even though the camera is operating properly. In general, a number of other noise factors can also reduce the robustness of the fault monitoring capability of the first layer alone.

Therefore, if the first layer indicates a fault condition, the method can proceed to either block 342 or 343, as indicated by decision block 341b depending on design considerations. Block 342 illustrates layer two or a network diagnostic layer. In layer two, the individual system metrics are compared against a collective system metric. In layer two, the system metrics can include the same system metrics used for the first layer. However, the behavior of each individual camera is compared to that of the entire camera network to improve the robustness of the fault condition detection.

If layer two indicates the earners is operating properly as shown by block 342a and decision block 342d, the method ends at block 365. If layer two indicates that the camera is not operating properly as shown by block 342a and decision block 342c, the method continues to block 350. However, if it remains unclear if the camera is operating properly as illustrated by block 342a and decision block 342b, the method can continue to layer three at block 343.

For example, the camera network can be selected (as at block 310) to be a set of cameras within a selected physical proximity. This physical proximity may be, for example, all the cameras at a given toll station, or all the cameras in adjacent roll stations. In addition, other selection criteria can be used to choose a camera network that maximizes the effectiveness of layer two. The key is to select a network of cameras which are likely to share similar types of noise sources as discussed above such as weather conditions, plate types, travelling speed when passing through the toll booth, etc. The network can be determined heuristically or based on historical data such as weather patterns, relative performance patterns of a set of cameras, camera model and specifications, maintenance/service records, etc., or empirically by collecting additional information such as camera behaviors in performance degradation, distributions of plate types, and mounting locations for each camera, etc.

In implementing layer two, a fault condition can be triggered if the system metrics of an individual camera in the network change relative to the other cameras in the network. This layer provides additional robustness against noises that are common for all the cameras in the selected network.

Returning to the examples provided above, if the ALPR yield decreases for all the cameras in the network based on external factors such as vehicle speed, environmental conditions such as rain, snow, fog, clouds, or sunlight, or quality of the identified plate, there will not be a relative change in the performance of an individual camera compared to all the cameras in the network. In this case, the method ends at block 365. However, if an individual camera's system metrics exceed a predetermined threshold relative to the camera network's system metric, the method can proceed to block 343 as shown in FIG. 3, or proceed to block 350, if a fault condition is identified for an individual camera in the camera network.

Layer two takes advantage of the “average” behavior of the camera network to identify fault conditions. In its simplest form, one can compare system metric(s) of an individual camera to the average performance of the network. For a more effective method, a probabilistic approach can be used in layer two. For example, if camera A in the camera network is likely to see half (50%) of the vehicles seen by camera B, their respective correlation on the collected system metrics used for the camera network can be weighted by 0.5. The probabilistic approach can be learned offline by tracking correlations of individual vehicles using ALPR, heuristic rules, or historical data.

Block 343 describes layer three, or a pair diagnostic layer, wherein the individual system metric for a pair of cameras is compared. In layer three, it is necessary to detect the same vehicle by a pair of cameras. Therefore, layer three requires individual vehicles be tracked via ALPR so that a link can be made between common vehicles seen by the pair of cameras. This can include tracking all the vehicles that pass at least two cameras using ALPR.

Layer three takes advantage of differences in the system metrics recorded for each of the pair of cameras for a common vehicle. As with layer two, layer three improves the robustness of the diagnostic routines. If a system metric for one of the pair of cameras drops below a predetermined threshold as compared to the other camera, the camera is not operating properly according to block 343a and decision block 343c, and a fault condition can be diagnosed as shown at block 350. If the camera is operating properly, as indicated by block 343a and decision block 343d, the method ends at block 365. In an alternative embodiment, layer three may also take advantage of more than two cameras. Since layer three relies on common vehicles passing a set of cameras, it is most suitable in certain configurations such as bridges and entrances/exits of a facility.

It should be appreciated that according to design considerations and system resources the three steps 341, 342, and 343 described in step 340 may be implemented in succession, one at a time, and in a necessary order. In general, block 341 requires the least system resources and therefore is preferably preformed as a “fast pass” identifier of a fault condition. In the event that block 341 is clearly indicative of camera degradation or error, the method can proceed directly to block 350 via block 341a and decision block 341c. Otherwise, from block 341, either bock 342 or 343 or both can next be implemented. Block 342 may require fewer system resources than block 343 because tracking and linking ALPR results of all vehicles, as required for block 343, may require extra resources. Again, if block 342 is clearly indicative of camera degradation or error as shown by block 342a and decision block 342c, the method can proceed directly from block 342 to block 350.

For example, in a preferred embodiment, layer one is used to screen for cameras that are not performing well. Only those cameras identified by layer one are then subject to layer two to further determine if the performance drop is simply due to other external noises, such as weather conditions, or if the camera is likely to have a fault condition. If the diagnostics result of layer two indicates with a high confidence level that the camera is operating properly or not operating properly (e.g., the camera performance is significantly worse or significantly better than the performance of the “average” behavior of other cameras in the network), the camera can be determined to be operative or faulty, respectively. In this case, application of layer three may not be necessary. If the diagnostics result of a camera is without sufficient confidence, then layer three can be implemented to examine the diagnostic outcome of the camera compared to another camera tracking the same set of vehicles to ensure the accuracy of determining whether the camera has a fault condition. When a fault condition is identified, it can be reported to an external system so that a service engineer can be sent to the camera site.

After the three layered approach outlined in block 340 is preformed, a fault condition that indicates a camera in the camera network is faulty can be identified as illustrated at block 350, according to the analysis preformed at block 340. At block 360 the fault condition can be reported to an external system so that a service technician can be sent to service the camera. The method ends at block 365.

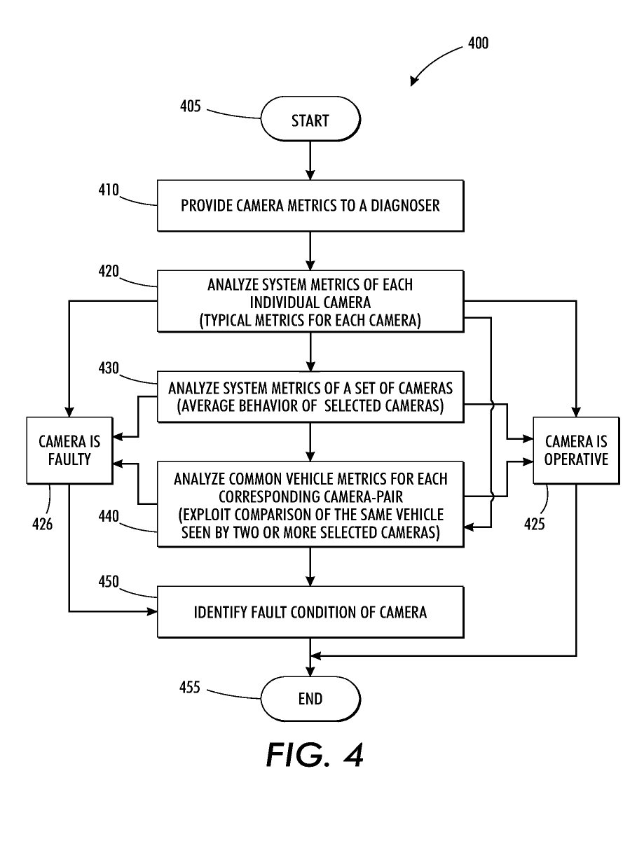

FIG. 4 illustrates a high level flow chart 400 of logical operational steps associated with a method for detecting camera degradation and faults in accordance with the disclosed embodiments. The method starts at block 405.

Block 410 shows that camera metrics can be provided to a diagnoser. Typically the diagnoser will be a computer module. The system metrics can include a number of different types of system metrics as discussed herein.

For example, at block 420, typical system metrics used to detect camera degradation are provided to the diagnoser for analysis. The diagnoser can analyze these metrics to determine if they indicate a fault condition with some measure of confidence. For example, the output can be very certain that the camera is operative, i.e., no fault, when the system performance metrics are on par or better than a predetermined threshold (T1) as shown at block 425. In this case, flow proceeds to block 455 and the diagnostics end. For another example, the output can be very certain that the camera is faulty when its system performance metrics are worse than another predetermined threshold (T2<T1) illustrated by block 426. In this case, flow proceeds to block 450 and the camera is identified as faulty. For yet another example, the output can be inconclusive, i.e., the system performance metrics are between the two thresholds T1 and T2. In this case, flow proceeds to 430 or 440 for further diagnostics.

Next, block 430 illustrates that system metrics indicative of the average behavior of a group of selected cameras can also be analyzed by the diagnoser. In this step, the diagnoser can advantageously compare an individual camera's performance relative to the remaining cameras to more accurately identify conditions suggesting that a camera's performance is faulty.

The diagnoser can also be provided common vehicle metrics for corresponding camera pairs where both cameras have identified the same vehicle as described by block 440. This allows the diagnoser to exploit the comparison of the same vehicle seen by two or more selected cameras to identify a fault condition as shown at block 450. The method ends at block 455.

It should be appreciated that steps 420, 430, and 440 can be implemented in a number of different orders and combinations. For example, in some cases it may be advantageous to only implement step 420. If step 420 is highly indicative of a fault condition, the method can skip steps 430 and 440 and proceed to step 450 wherein a fault condition of a camera is identified, Likewise, in some instances block 420 may advantageously be skipped and only steps 430 or 440 implemented.

In general, it should be understood that steps 420, 430, and 440 can be organized in any necessary order and with any of the three steps omitted depending on the circumstances of detection. This is true because each of steps 420, 430, and 440, offers a different level of detection capability at the expense of decreased computational efficiency. Therefore, FIG. 4 is offered simply as an illustrative embodiment but is not intended to limit the invention to the order of steps shown.

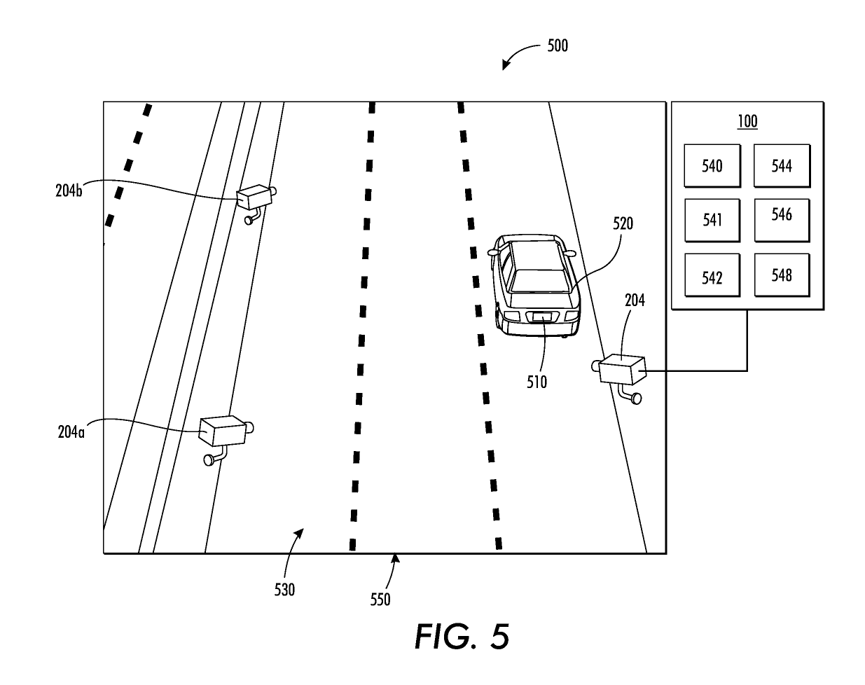

FIG. 5 illustrates a system for detecting camera degradation and faults 500 in accordance with an embodiment of the present invention. A plurality of cameras 204, 204a, and 204b can be disposed in an environment 550. Typically this environment can be a traffic intersection, roadway 530, highway, bridge, toll station, or other vehicular transportation environment. The plurality of cameras can include a group of cameras selected as a camera network. In FIG. 5, for example, cameras 204, 204a, and 204b could from a camera network. It should be appreciated that the camera network can be selected to include additional or fewer cameras.

A vehicle 520 with license plate 510 can be detected by one, some, or all the cameras in the camera network. Automated License Plate Recognition module 541, associated with computer system 100, can be used to identify the license plates such as license plate 510 associated with vehicle 520. Data from the detection of the vehicles can be used as a metric indicative of camera degradation. This data is provided via a network such as network 200 to a computer system such as computer system 100. Computer system 100 includes a number of modules for receiving and analyzing the data provided by the camera network.

Computer system 100 can include a number of modules such as a diagnoser module 540 for analyzing the data provided to the computer system 100. In addition, the computer system can include a First Layer module 542, a Second Layer module 544, and a Third Layer module 546. The First Layer module 542 can implement, for example, method step 341 wherein the individual system metrics for each camera in the network are evaluated. The Second Layer 544 module can implement method step 342 wherein individual system metrics are compared to a collective system metric. The Third Layer module 546 can implement method step 343 wherein individual system metrics for a pair of cameras that have both identified the same vehicle, such as camera 204 and 204a in FIG. 5, can be compared.

In addition, computer system 100 can include an identification module 548 that can identify a fault condition based on the three-layered approach (method step 340), and report the fault condition so that a service technician can be dispatched to address the fault condition.

Based on the foregoing, it can be appreciated that a number of embodiments, preferred and alternative, are disclosed herein. For example, in one embodiment, a method for detecting camera error comprises identifying a plurality of cameras comprising a camera network, collecting at least one system metric indicative of the camera's performance, analyzing the system metrics according to at least one of a plurality of diagnostics layers comprising an individual diagnostic layer, a network diagnostic layer, and a pair diagnostic layer, and identifying a fault condition indicative of a faulty camera in the camera network according to the diagnostic layers. The individual diagnostic layer is also configured for tracking the system metrics for each of the cameras in the camera network and indicating a fault condition when the system metrics are degraded by more than a predetermined amount.

The network diagnostic layer is configured for tracking at least one individual system metric for each of the cameras in the camera network, tracking at least one collective system metric for all the cameras in the camera network, comparing the collective system metrics to the individual system metrics, and indicating a fault condition when the individual system metrics are worse than the collective system metrics by more than a predetermined amount.

In another embodiment, the pair diagnostic layer is further configured for identifying at least one target object passing at least two of the cameras in the camera network, tracking the individual system metrics for each of the at least two cameras in the camera network, comparing the system metrics of the at least two cameras in the camera network, and indicating a fault condition when the system metrics of one of the at least two cameras in the camera network are worse than the system metrics of the remaining of the at least two cameras in the camera network by more than a predetermined amount.

Identifying a fault condition indicative of a faulty camera can further comprise applying at least two of the plurality of diagnostic layers comprising the individual diagnostic layer, the network diagnostic layer, and the pair diagnostic layer, and identifying a fault condition indicative of a faulty camera in the camera network when all of the at least two of the plurality of diagnostic layers applied indicates a fault condition.

The system metrics indicative of the camera's performance can comprise at least one of an automated license plate recognition yield, a negative of measured geometric distortion parameters of captured license plates, measured sharpness parameters of captured license plates, and Optical Character Recognition confidence levels. The plurality of cameras can comprise traffic surveillance video cameras.

In yet another embodiment, a method for detecting camera error comprises identifying a plurality of cameras comprising a camera network, collecting at least one system metric indicative of the camera's performance, analyzing the system metrics according to at least one of a plurality of diagnostics layers comprising an individual diagnostic layer, a network diagnostic layer, and a pair diagnostic layer, applying at least two of the plurality of diagnostic layers comprising the individual diagnostic layer, the network diagnostic layer, and the pair diagnostic layer, and identifying a fault condition indicative of a faulty camera in the camera network when all of the at least two of the plurality of diagnostic layers applied indicates a fault condition.

The individual diagnostic layer is also configured for tracking the system metrics for each of the cameras in the camera network and indicating a fault condition when the system metrics are degraded by more than a predetermined amount.

The network diagnostic layer is further configured for tracking at least one individual system metric for each of the cameras in the camera network, tracking at least one collective system metric for all the cameras in the camera network, comparing the collective system metrics to the individual system metrics, and indicating a fault condition when the individual system metrics are worse than the collective system metrics by more than a predetermined amount.

The pair diagnostic layer is further configured for identifying at least one target object passing at least two of the cameras in the camera network, tracking at least one individual system metric for each of the at least two cameras in the camera network, comparing the individual system metrics of the at least two cameras in the camera network, and indicating a fault condition when the individual system metrics of one of the at least two cameras in the camera network are worse than the system metrics of the remaining of the at least two cameras in the camera network by more than a predetermined amount.

In another embodiment, the at least one system metric indicative of the camera's performance can comprise at least one of an automated license plate recognition yield, a negative of measured geometric distortion parameters of captured license plates, measured sharpness parameters of captured license plates, and Optical Character Recognition confidence. The plurality of cameras can comprise traffic surveillance video cameras.

A system for detecting camera degradation and faults comprises a processor, a data bus coupled to the processor, and a computer-usable medium embodying computer code, the computer-usable medium being coupled to the data bus, the computer code comprising instructions executable by the processor configured for: identifying a plurality of cameras comprising a camera network, collecting at least one system metric indicative of the camera's performance, analyzing the system metrics according to at least one of a plurality diagnostics layers comprising an individual diagnostic layer, a network diagnostic layer, and a pair diagnostic layer, and identifying a fault condition indicative of a faulty camera in the camera network according to the plurality of diagnostic layers.

The individual diagnostic layer is further configured for tracking the system metrics for each of the cameras in the camera network, and indicating a fault condition when the system metrics are degraded by more than a predetermined amount.

The network diagnostic layer is further configured for tracking at least one individual system metric for each of the cameras in the camera network, tracking at least one collective system metric for all the cameras in the camera network, comparing the collective system metrics to the individual system metrics, and indicating a fault condition when the individual system metrics are worse than the collective system metrics by more than a predetermined amount.

The pair diagnostic layer can be further configured for identifying at least one target object passing at least two of the cameras in the camera network, tracking the individual system metrics for each of the at least two cameras in the camera network; comparing the system metrics of the at least two cameras in the camera network, and indicating a fault condition when the system metrics of one of the at least two cameras in the camera network are worse than the system metrics of the remaining of the at least two cameras in the camera network by more than a predetermined amount.

In another embodiment, the instructions are further configured for applying at least two of the plurality of diagnostic layers comprising the individual diagnostic layer, the network diagnostic layer, and the pair diagnostic layer, and identifying a faulty camera when all of the at least two of the plurality of diagnostic layers applied indicates a fault condition.

In yet another embodiment, the system metrics indicative of the camera's performance comprises of at least one of an automated license plate recognition yield, a negative of measured geometric distortion parameters of captured license plates, measured sharpness parameters of captured license plates, and Optical Character Recognition confidence. The plurality of cameras can comprise traffic surveillance video cameras.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for detecting camera degradation and faults, said method comprising:
identifying a plurality of cameras comprising a camera network;
collecting at least one system metric indicative of a performance of said at least one camera among said plurality of cameras;
analyzing said at least one system metric according to at least one of a plurality of diagnostics layers comprising an individual diagnostic layer, a network diagnostic layer, and a pair diagnostic layer; and
identifying a fault condition indicative of a faulty camera among said plurality of cameras in said camera network according to said plurality of diagnostic layers.

2. The method of claim 1 further comprising configuring said individual diagnostic layer to:
track said at least one system metric for each camera among said plurality of cameras in said camera network; and
indicate a fault condition when said at least one system metric is degraded by more than a predetermined amount.

3. The method of claim 2 further comprising configuring said network diagnostic layer to:
track at least one individual system metric for each camera among said plurality of cameras in said camera network;
track at least one collective system metric for said plurality of cameras in said camera network;
compare said at least one collective system metric to said at least one individual system metric; and
indicate a fault condition when said at least one individual system metric is worse than said at least one collective system metric by more than a predetermined amount.

4. The method of claim 3 further comprising configuring said pair diagnostic layer to:
identify at least one target object passing at least two cameras among said plurality of cameras in said camera network;
track said at least one individual system metric for each of said at least two cameras among said plurality of cameras in said camera network;
compare said at least one individual system metric of said at least two cameras among said plurality of cameras in said camera network; and
indicate a fault condition when said individual system metric of one of said at least two cameras among said plurality of cameras in said camera network are worse than said individual system metric of remaining of said at least two among said plurality of cameras in said camera network by more than a predetermined amount.

5. The method of claim 4 wherein identifying a fault condition indicative of a faulty camera further comprises:
applying at least two of said plurality of diagnostic layers comprising said individual diagnostic layer, said network diagnostic layer, and said pair diagnostic layer; and
identifying a fault condition indicative of a faulty camera when all of said at least two of said plurality of diagnostic layers applied indicates a fault condition.

6. The method of claim 1 wherein said at least one system metric comprises at least one of:
automated license plate recognition yield;
negative of measured geometric distortion parameters of captured license plates;
measured sharpness parameters of captured license plates; and
Optical Character Recognition confidence levels.

7. The method of claim 1 wherein said plurality of cameras comprises traffic surveillance video cameras.

8. A method for detecting camera degradation and faults comprising:
identifying a plurality of cameras comprising a camera network;
collecting at least one system metric indicative of a performance of said at least one camera among said plurality of cameras;
analyzing said at least one system metric according to at least one of a plurality of diagnostics layers comprising an individual diagnostic layer, a network diagnostic layer, and a pair diagnostic layer;
applying at least two of said plurality of diagnostic layers comprising said individual diagnostic layer, said network diagnostic layer, and said pair diagnostic layer, wherein all of said at least two of said plurality of diagnostic layers applied indicates a fault condition; and
identifying a fault condition indicative of a faulty camera in said camera network according to said at least two of said plurality of diagnostic layers.

9. The method of claim 8 further comprising configuring said individual diagnostic layer to:
track said at least one system metric for each camera among said plurality of cameras in said camera network; and
indicate a fault condition when said at least one system metric is degraded by more than a predetermined amount.

10. The method of claim 8 further comprising configuring said network diagnostic layer to:
track at least one individual system metric for each camera among said plurality of cameras in said camera network;
track at least one collective system metric for said plurality of cameras in said camera network;
compare said at least one collective system metric to said at least one individual system metric; and
indicate a fault condition when said at least one individual system metric is worse than said at least one collective system metric by more than a predetermined amount.

11. The method of claim 8 further comprising configuring said pair diagnostic layer to:
identify at least one target object passing at least two cameras among said plurality of cameras in said camera network;
track said at least one individual system metric for each of said at least two cameras among said plurality of cameras in said camera network;
compare said at least one individual system metric of said at least two cameras among said plurality of cameras in said camera network; and
indicate a fault condition when said individual system metric of one of said at least two cameras among said plurality of cameras in said camera network are worse than said individual system metric of remaining of said at least two among said plurality of cameras in said camera network by more than a predetermined amount.

12. The method of claim 8 wherein said at least one system metric comprises at least one of:
automated license plate recognition yield;
negative of measured geometric distortion parameters of captured license plates;
measured sharpness parameters of captured license plates; and
Optical Character Recognition confidence levels.

13. The method of claim 8 wherein said plurality of cameras comprises traffic surveillance video cameras.

14. A system for detecting camera degradation and faults, said system comprising:
a processor;
a data bus coupled to said processor; and
a computer-usable medium embodying computer code, said computer-usable medium being coupled to said data bus, said computer code comprising instructions executable by said processor configured for:
identifying a plurality of cameras comprising a camera network;
collecting at least one system metric indicative of a performance of said at least one camera among said plurality of cameras;
analyzing said at least one system metric according to at least one of a plurality of diagnostics layers comprising an individual diagnostic layer, a network diagnostic layer, and a pair diagnostic layer; and
identifying a fault condition indicative of a faulty camera among said plurality of cameras in said camera network according to said plurality of diagnostic layers.

15. The system of claim 14 wherein said individual diagnostic layer is further configured to:
track said at least one system metric for each camera among said plurality of cameras in said camera network; and
indicate a fault condition when said at least one system metric is degraded by more than a predetermined amount.

16. The system of claim 15 wherein said network diagnostic layer is further configured to:
track at least one individual system metric for each camera among said plurality of cameras in said camera network;
track at least one collective system metric for said plurality of cameras in said camera network;
compare said at least one collective system metric to said at least one individual system metric; and
indicate a fault condition when said at least one individual system metric is worse than said at least one collective system metric by more than a predetermined amount.

17. The system of claim 16 wherein said pair diagnostic layer is further configured to:
identify at least one target object passing at least two cameras among said plurality of cameras in said camera network;
track said at least one individual system metric for each of said at least two cameras among said plurality of cameras in said camera network;
compare said at least one individual system metric of said at least two cameras among said plurality of cameras in said camera network; and
indicate a fault condition when said individual system metric of one of said at least two cameras among said plurality of cameras in said camera network are worse than said individual system metric of remaining of said at least two among said plurality of cameras in said camera network by more than a predetermined amount.

18. The system of claim 17 wherein said instructions are further configured for:
applying at least two of said plurality of diagnostic layers comprising said individual diagnostic layer, said network diagnostic layer, and said pair diagnostic layer; and
identifying a fault condition indicative of a faulty camera when all of said at least two of said plurality of diagnostic layers applied indicates a fault condition.

19. The system of claim 14 wherein said at least one system metric comprises at east one of:
automated license plate recognition yield;
negative of measured geometric distortion parameters of captured license plates;
measured sharpness parameters of captured license plates; and
Optical Character Recognition confidence levels.

20. The system of claim 14 wherein said plurality of cameras comprises traffic surveillance video cameras.
